(19) United States
(12) Patent Application Publication
(10) Pub. No.: US 2019/0063114 A1
(43) Pub. Date: Feb. 28, 2019

(54) REFRIGERATOR FREEZER UNIT AND SAFETY LOCK

(71) Applicant: Minus Forty Holdings Corp., Georgetown (CA)

(72) Inventors: Julian Attree, Georgetown (CA); Marinko Tepic, Mississauga (CA); Alexander Dukhovniy, Thornhill (CA); Ausdell Hadaway, Mississauga (CA)

(21) Appl. No.: 15/890,634

(22) Filed: Feb. 7, 2018

Related U.S. Application Data
(60) Provisional application No. 62/552,317, filed on Aug. 30, 2017.

(51) Int. Cl. E05B 65/00; E05B 63/00; F25D 17/06; F25D 17/08; F25D 23/02

(52) U.S. Cl. CPC E05B 65/0053; E05B 63/0069; F25D 2700/02; F25D 17/08; F25D 23/028; F25D 17/065

(57) ABSTRACT

A refrigerator freezer unit having a single refrigeration unit allowing to provide cold air to both a freezer and refrigerator compartment. The freezer refrigerator unit has an intake channel and recirculating channel allowing to displace cold air within the freezer and refrigerator compartment. The refrigerator freezer unit also has a safety lock allowing automatically controlled locking, and manual unlocking of the refrigerator and/or freezer compartment from either the exterior or interior of the unit.

### FIELD OF THE INVENTION

The present invention pertains to refrigerator freezer units and more particularly to a refrigeration freezer unit which has a single refrigeration unit for the refrigerator and freezer compartments.

### BACKGROUND OF THE INVENTION

The presence of a refrigerator freezer unit is commonplace within a number of commercial establishments, specifically, refrigerator freezer units which have a first compartment for use as a refrigerator and a second compartment for use as a freezer. A typical refrigerator freezer unit has a refrigeration unit for each compartment wherein each refrigeration unit is responsible for providing cool air to either the refrigerator or the freezer compartments. Such units consume more energy for the sheer fact that two independent refrigeration units are used to cool the two compartments in the unit.

Therefore, there is a need for a more efficient refrigerator freezer unit which does not require two independent refrigeration units to cool the refrigerator and freezer compartments. The present invention provides a refrigerator freezer unit which only utilises a single refrigeration unit to cool both the refrigerator and freezer unit.

There is also a need for a safety lock allowing to unlock a refrigerator or freezer compartment from either the exterior or interior of these compartments.

### SUMMARY OF THE INVENTION

The present invention provides a refrigerator freezer unit comprising a single refrigeration unit connected to a freezer compartment for providing cold air to the freezer compartment and an intake channel interconnected to the freezer compartment for providing cold air to a refrigerator compartment. The refrigerator freezer unit also has a recirculating channel allowing to recirculate air within the refrigerator compartment and one or more intake fans positioned in the intake channel for displacing air in the intake channel as well as one or more recirculating fans positioned in the recirculating channel for displacing air in the recirculating channel wherein the refrigerator and freezer compartments are cooled by the single refrigeration unit.

The present invention also provides a safety lock for use with a refrigerated or freezer compartment which has a lock release pin allowing to unlock the safety lock from the exterior of a refrigerated or freezer compartment. The safety lock also has an entrapment release interconnected to the release pin allowing to unlock the safety lock from within a refrigerator or freezer compartment.

### BRIEF DESCRIPTION OF THE DRAWINGS

The embodiments of the present invention will now be described by reference to the following figures, in which identical reference numerals in different figures indicate identical elements and in which:

FIG. 1 is a perspective view of a refrigerator freezer unit according to one embodiment of the present invention;

FIG. 2a is a disassembled perspective view of a refrigerator freezer unit according to one embodiment of the present invention;

FIG. 2b is a disassembled top perspective view of a refrigerator freezer unit according to one embodiment of the present invention;

FIG. 2c is a further disassembled top perspective view of a refrigerator freezer unit according to one embodiment of the present invention;

FIG. 2d is a further disassembled top perspective view showing the intake and recirculating channel used in a refrigerator freezer unit according to one embodiment of the present invention;

FIG. 3 is a side cut away view of the flow of air within the intake and recirculating channel as used in a refrigerator freezer unit according to one embodiment of the present invention;

FIG. 4a is a side cut away view of the flow of air exiting the outlet port of the recirculating channel as used in a refrigerator freezer unit according to one embodiment of the present invention;

FIG. 4b is a side cut away perspective view of the inlet port for the intake channel as used in a refrigerator freezer unit according to one embodiment of the present invention;

FIG. 4c is a side cut away perspective view of the intake channel positioned underneath the floor portion of the refrigerator compartment according to one embodiment of the present invention;

FIG. 4d is a cut away side perspective view of the outlet port for the recirculating channel as used in a refrigerator freezer unit according to one embodiment of the present invention;

FIG. 5 is a top side cut away perspective view of the intake and recirculating channels superposed on one another according to one embodiment of the present invention;

FIG. 6 is a top side cut away perspective view of the intake and recirculating channels outlet ports according to one embodiment of the present invention; and

FIG. 7 is a side cut away view of the outlet ports of the intake and recirculating channels according to one embodiment of the present invention.

FIG. 8 is a side cut away view of another embodiment of the present invention with a louvered opening positioned within the refrigerator compartment and evaporator fan housing;

FIG. 9 is a side cut away perspective view of another embodiment of the present invention with a louvered opening positioned within the refrigerator compartment and evaporator fan housing;

FIG. 10 is perspective view of a refrigerator freezer unit of the present invention having two safety locks positioned on the compartments of the unit according to one embodiment of a safety lock;

FIG. 11 is a side view of a safety lock according to one embodiment of the present invention;

FIG. 12 is a side view of a safety lock according to one embodiment of the present invention with the outer shell removed;

FIG. 13 is a top perspective view of the entrapment release and lock release pin present in a safety lock according to one embodiment of the present invention;

FIG. 14 is a perspective view of the button allowing to activate the entrapment release from within a refrigerator or freezer compartment;

FIG. 15 is a top perspective view of the tubular body of the entrapment release positioned within a safety lock according to one embodiment of the present invention.

The Figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention.

### DETAILED DESCRIPTION OF THE INVENTION

The terms “coupled” and “connected”, along with their derivatives, may be used herein. It should be understood that these terms are not intended as synonyms for each other. Rather, in particular embodiments, “connected” may be used to indicate that two or more elements are in direct physical or electrical contact with each other. The terms “Coupled” and “Interconnected” may be used to indicate that two or more elements are in either direct or indirect (with other intervening elements between them) physical or electrical contact with each other, or that the two or more elements co-operate or interact with each other (e.g. as in a cause and effect relationship).

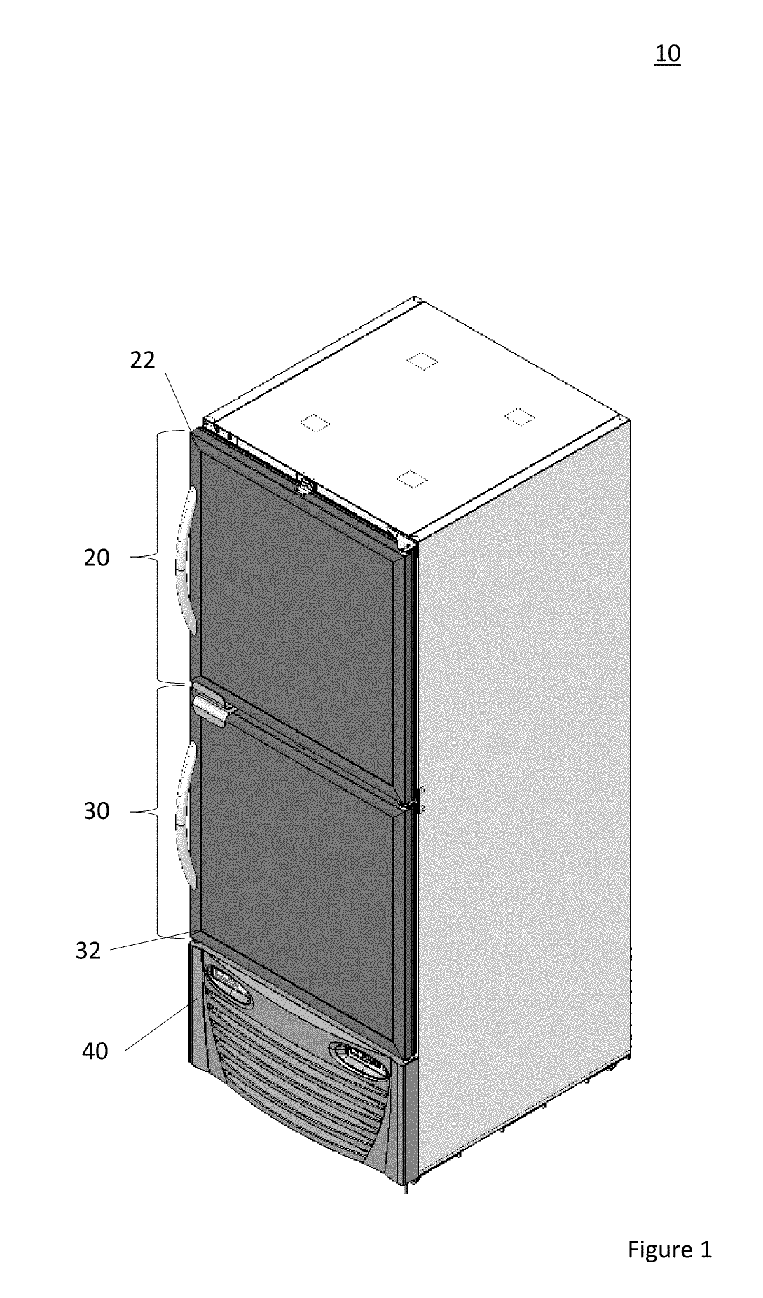

The present invention includes a refrigerator freezer unit 10 as shown in FIG. 1 according to one embodiment of the present invention. The refrigerator freezer unit 10 has a refrigerator compartment 20 positioned in the upper section of unit 10. The refrigerator compartment 20 has a door 22 as would be found in any refrigerator unit. The freezer compartment 30 is positioned underneath the refrigerator compartment 20 and also has a door 32 as would be found in any common freezer unit. The bottom portion of refrigerator freezer unit 10 is the refrigeration compartment 40 which houses the single refrigeration unit (not shown). The refrigeration unit used in the present unit is a commonly used refrigeration unit as would be known by a worker skilled in the relevant art. The refrigeration unit is in fluid communication with the freezer compartment 30 allowing the transfer of thermal energy from the freezer compartment 30. The refrigeration unit is not in direct fluid communication with the refrigeration compartment 20 since cold air is transferred to the refrigeration compartment 20 through freezer compartment 30 as will be further described below.

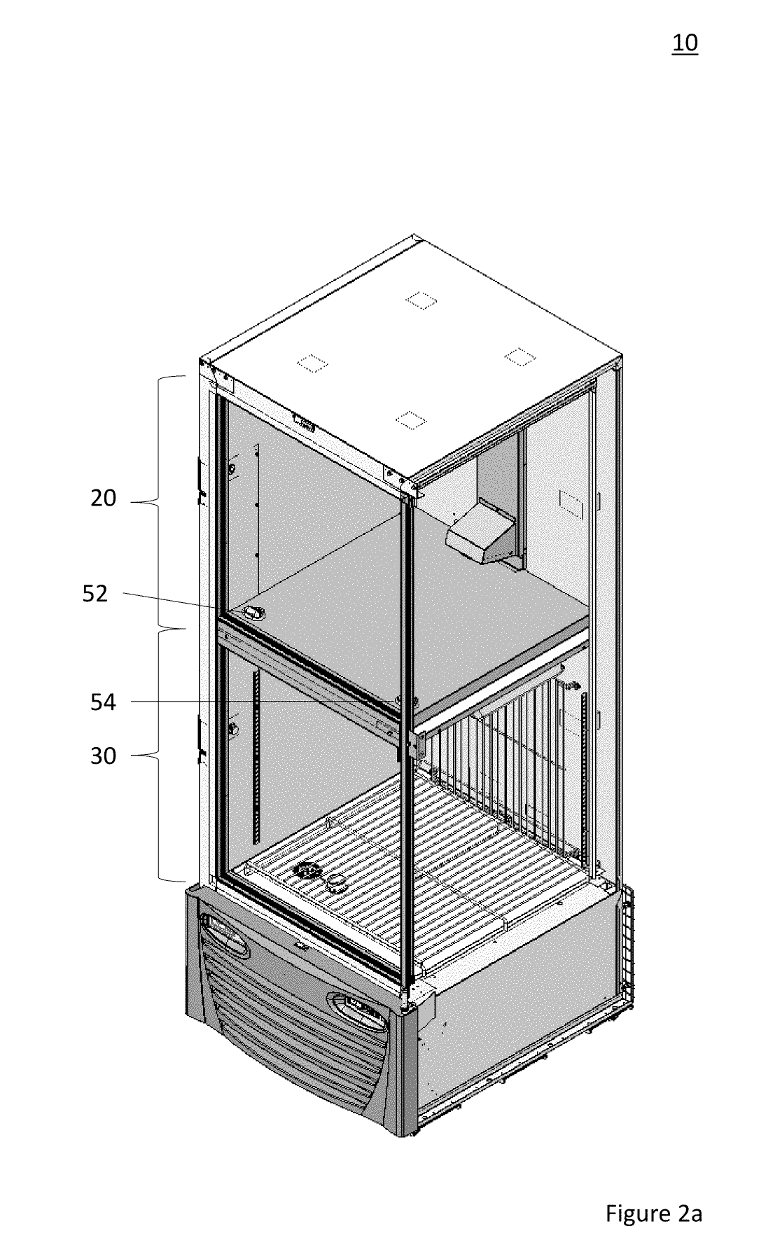

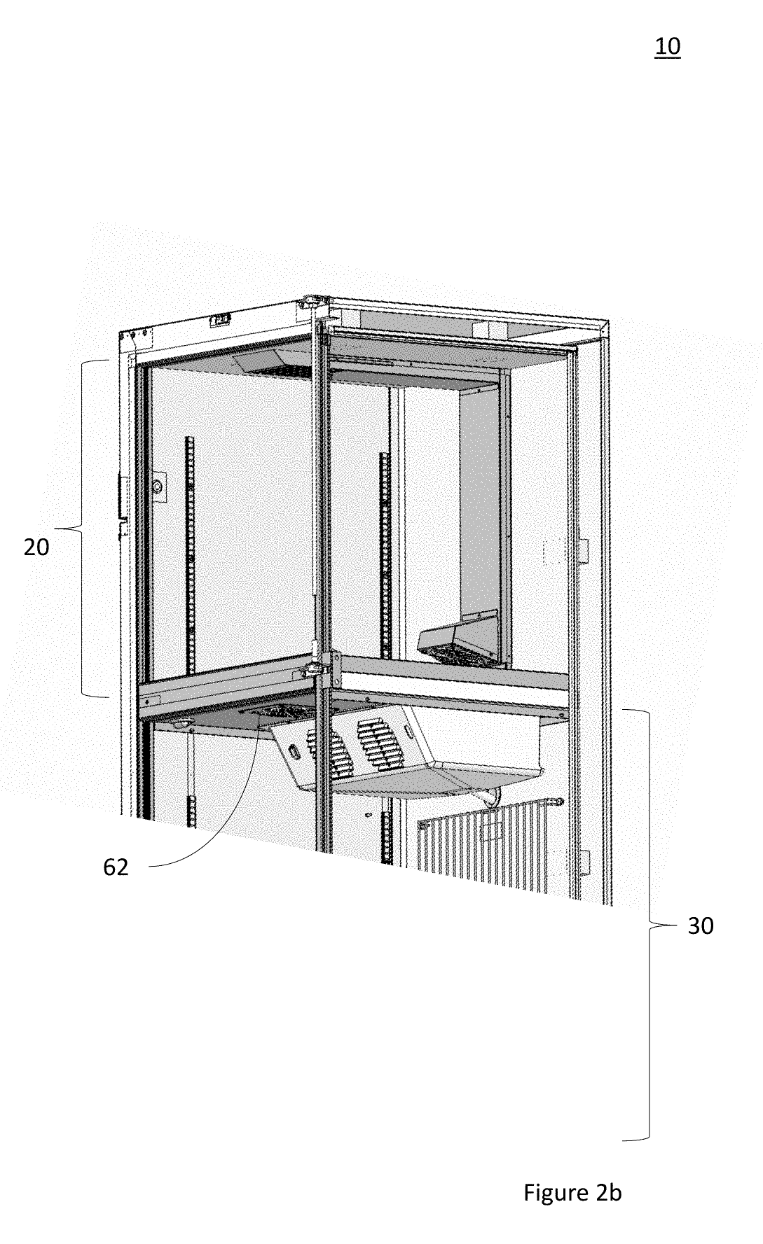

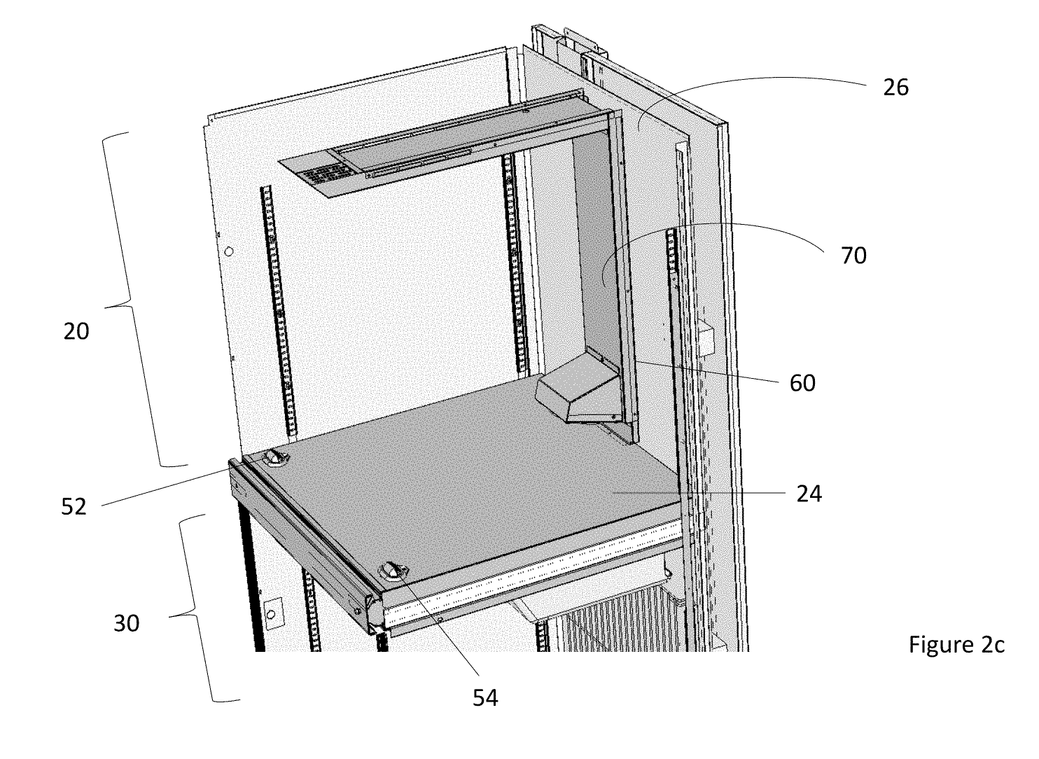

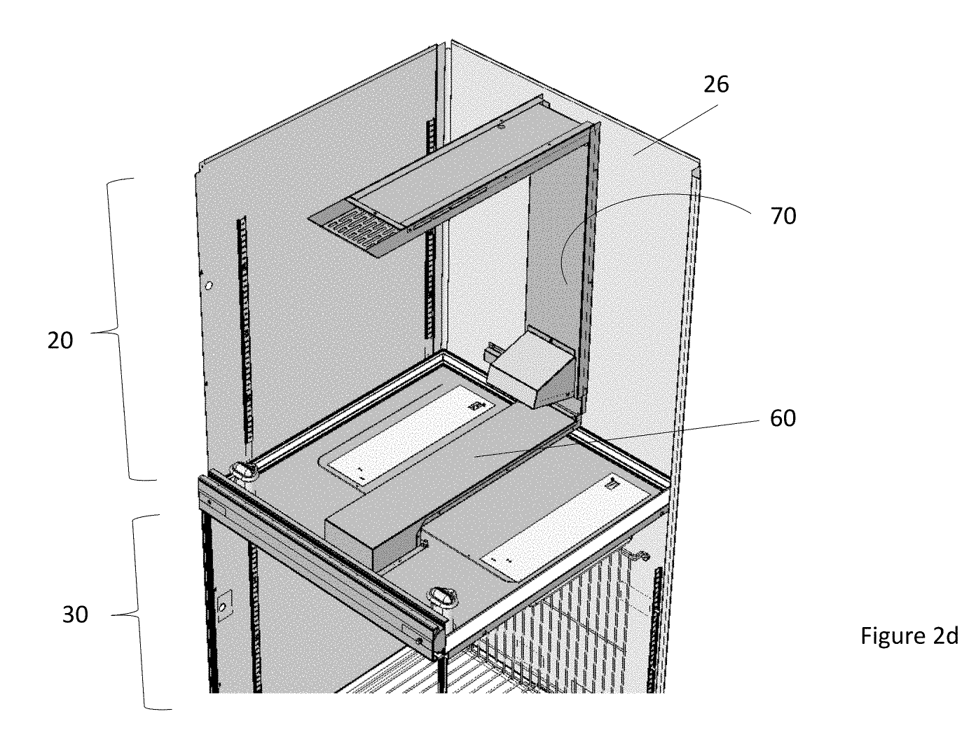

With reference to FIGS. 2a-2b refrigerator freezer unit 10 has the doors to each compartment removed as well as a side wall in order to better illustrate the elements of the present invention according to one embodiment. The refrigerator and freezer compartments 20 and 30 are independent other than through some fluid communication defined by inlet port 62 of intake channel (not shown) positioned on the top surface of freezer compartment 30. As will be further described, the intake channel allows the transfer of cold air to the refrigerator compartment 20 without the need for an independent refrigeration unit dedicated to the refrigeration compartment 20. Louvered openings 52 and 54 also allow for the transfer of warm air from the refrigerator compartment 20 to the freezer compartment 30. Louvered openings 52 and 54 are openings as would be known by a worker skilled in the relevant art.

With reference to FIGS. 2c-2d and according to one embodiment of the present invention, refrigerator freezer unit 10 has the top, front and side walls removed to better illustrate intake channel 60 and recirculating channel 70 allowing for fluid communication between the refrigerator and freezer compartment of unit 10. With specific reference to FIG. 2c, louvered openings 52 and 54 are shown on the floor portion 24 of refrigerator compartment 20 allowing fluid communication of warm air from the refrigerator compartment 20 to the freezer compartment 30 upon the pressure difference between refrigerator compartment 20 and freezer compartment 30 created by intake fan 66 (not shown). With specific reference to FIG. 2d, intake channel 60 is shown in greater detail with the floor of refrigerator compartment 20 being removed allowing a better illustration of intake channel 60. Intake channel 60 is a closed channel allowing fluid communication of cold air from the freezer compartment to the upper portion of refrigerator compartment 20. As will be further described below, recirculating channel 70 is superposed on intake channel 60 and each channel is independent of one another. As shown in FIGS. 2c and 2d, both channels travel along the back wall 26 of refrigerator freezer unit allowing air to be transported to the upper portion of unit.

With further reference to FIG. 2d and according to one embodiment of the present invention, the general shape of the intake channel is U-shape whereas the general shape of the recirculating channel is L-shape.

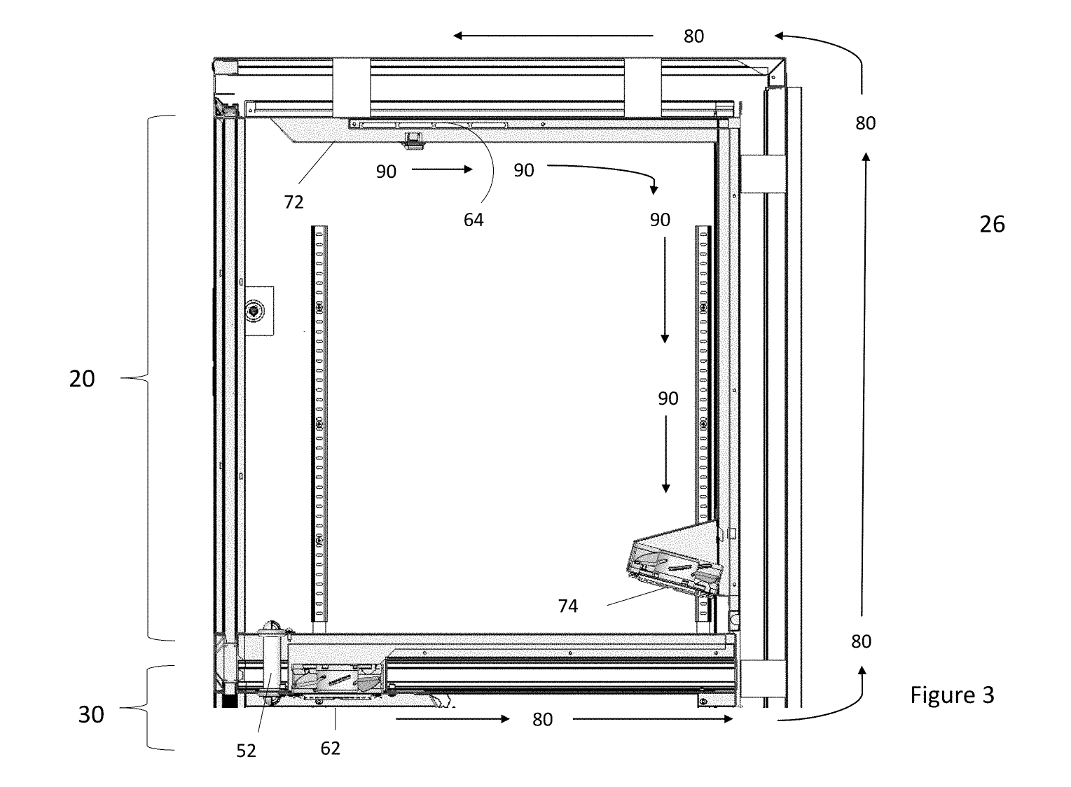

With reference to FIG. 3 and according to one embodiment of the present invention, the fluid movement of cold air from the freezer compartment 30 to refrigerator compartment 20 is shown through arrows associated with numeral 80. The arrows 80 are positioned outside of intake channel 60 for ease of reference, however, all air in the intake channel 60 travels within the channel. The flow of air being recirculated within the refrigerator compartment 20 is shown through arrows associated with numeral 90 and travels within recirculating channel 70 at all times. Arrows 90 are positioned outside of recirculating channel 70 for ease of reference. As will be described, the flow of air described by arrows 80 and 90 are independent of each other and within closed channels. The entry point for cold air into intake channel 60 is at inlet port 62 and the discharge of cold air into refrigerator compartment 20 is at outlet port 64. The entry point for recirculating channel 70 is at inlet port 72 with the discharge of recirculated air being at outlet port 74. All recirculated air traveling within recirculating channel 70 is within refrigerator compartment 20. The movement of cold air within intake channel 60 and recirculating channel 70 allows for cold air from the freezer compartment 30 to be transferred to refrigerator compartment 20 without the need for a second refrigeration unit.

With further reference to FIG. 3 and according to one embodiment of the present invention, louvered opening 52 is shown. The placement of louvered opening 52 allows for warm air to travel from the refrigerator compartment 20 to the freezer compartment 30. The travel of warm air to the freezer compartment is dependent upon operational state of intake fan 66 (not shown).

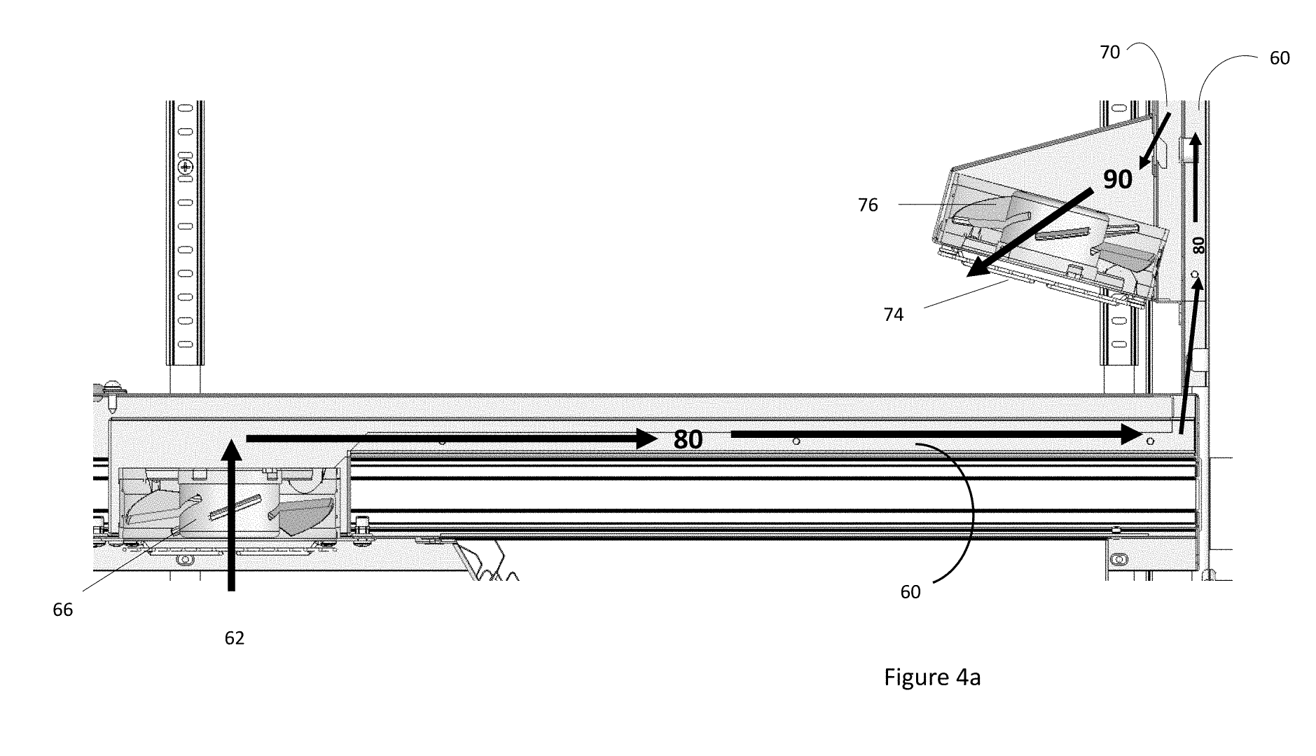

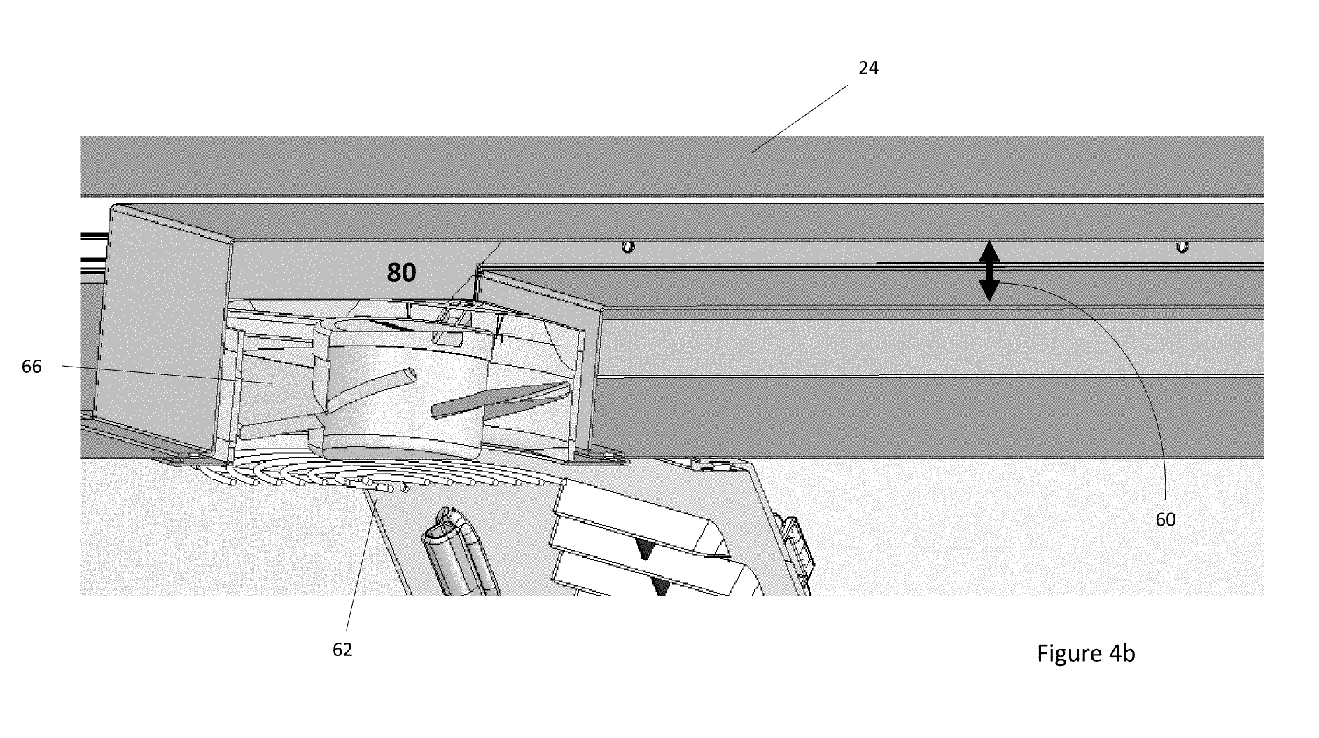

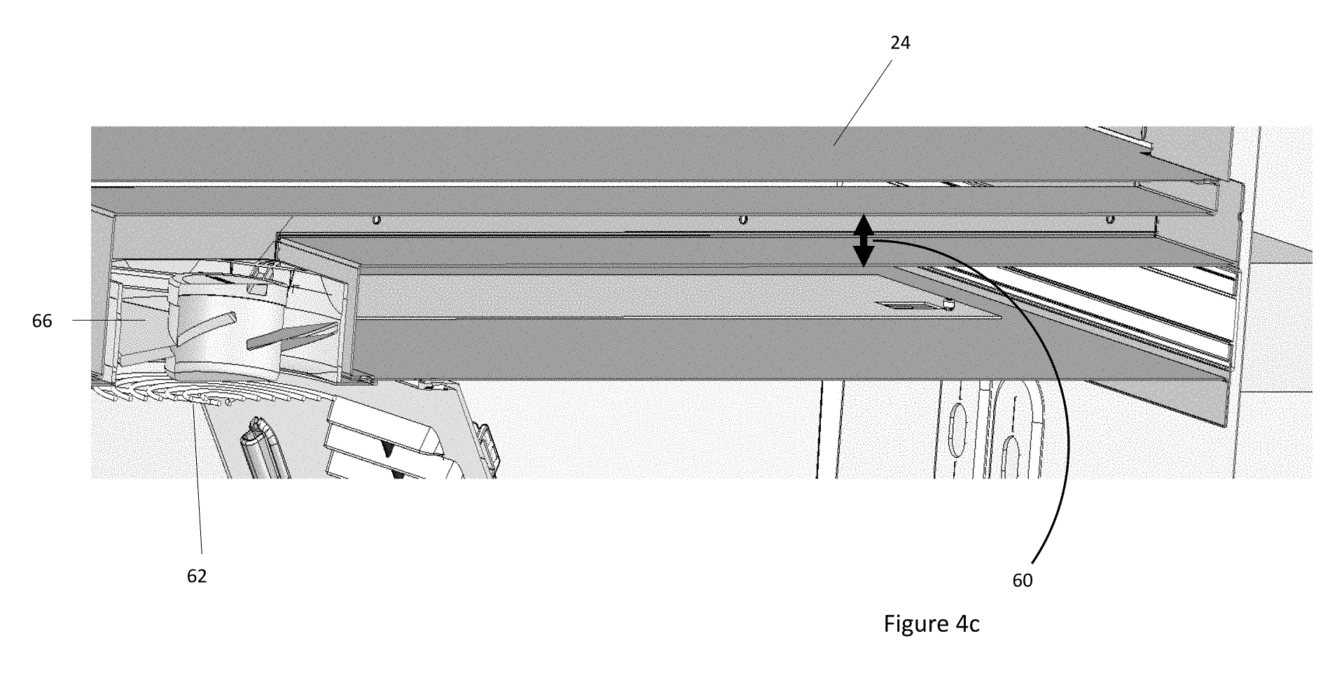

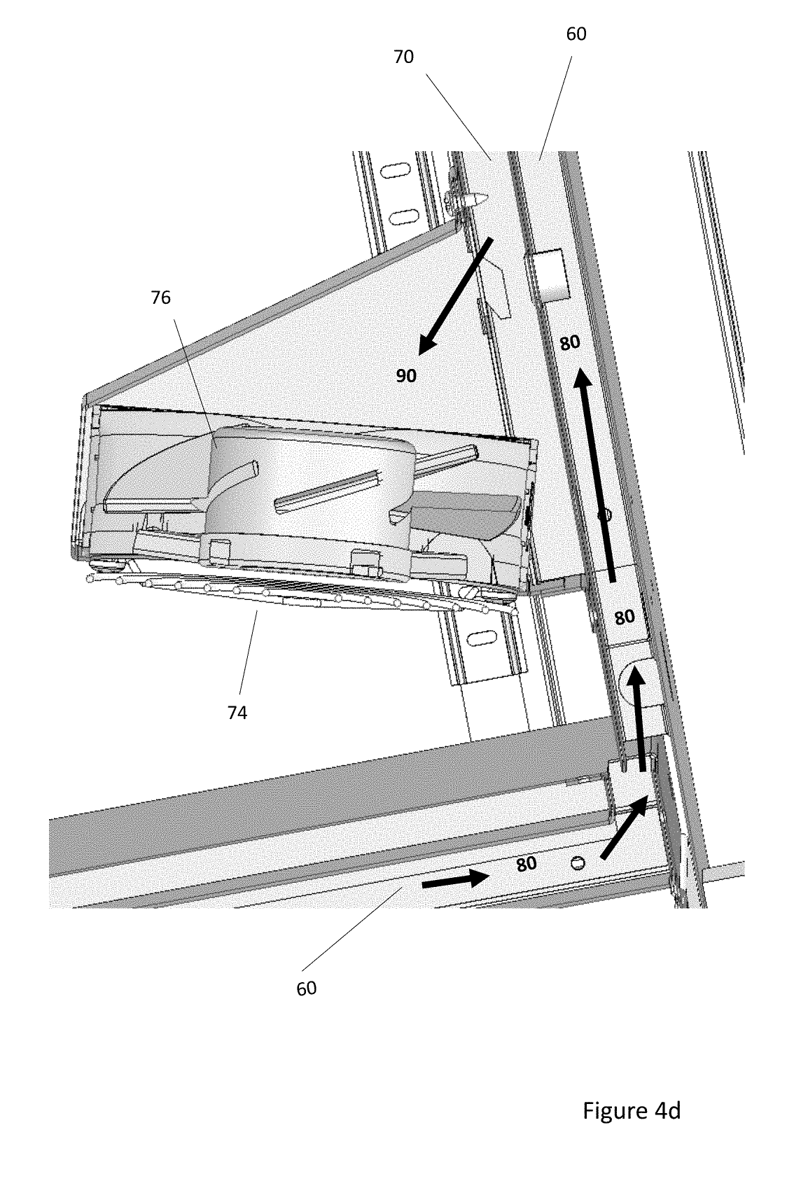

With reference to FIG. 4a and according to one embodiment of the present invention, air flow 80 in intake channel 60 is further described. Cold air from the freezer compartment is in fluid communication with inlet port 62 of intake channel 60 and is discharged into intake channel 60 through intake fan 66. Once activated, intake fan 66 will displace air 80 into intake channel 60 and will push air through intake channel 60 until air 80 reaches an outlet port (not shown) for discharge into the refrigerator compartment. The air circuit for recirculating air in the refrigerator compartment commences at an inlet port (not shown) of recirculating channel 70. Air within the refrigerator compartment is drawn into recirculating channel 70 by recirculating fan 76 until air flow 90 reaches an outlet port 74 for discharge into the refrigerator compartment.

With reference to FIGS. 4b-4c and according to one embodiment of the present invention, the intake of air in intake channel 60 is further described. Air from the freezer compartment enters intake channel 60 at inlet port 62 by being drawn in by intake fan 66. Air 80 will travel within enclosed intake channel 60 positioned underneath floor portion 24 of refrigerator compartment and will then travel along the back wall of refrigerator compartment.

With reference to FIG. 4d and according to one embodiment of the present invention, air 80 within intake channel 60 transitions from the floor portion of the intake channel into the wall portion of intake channel 60. Recirculating air 90 enters into recirculating channel 70 through inlet port (not shown) after being drawn-in by recirculating fan 76 and travels directly into the wall portion of recirculating channel 70 along the backwall portion of the refrigerator compartment.

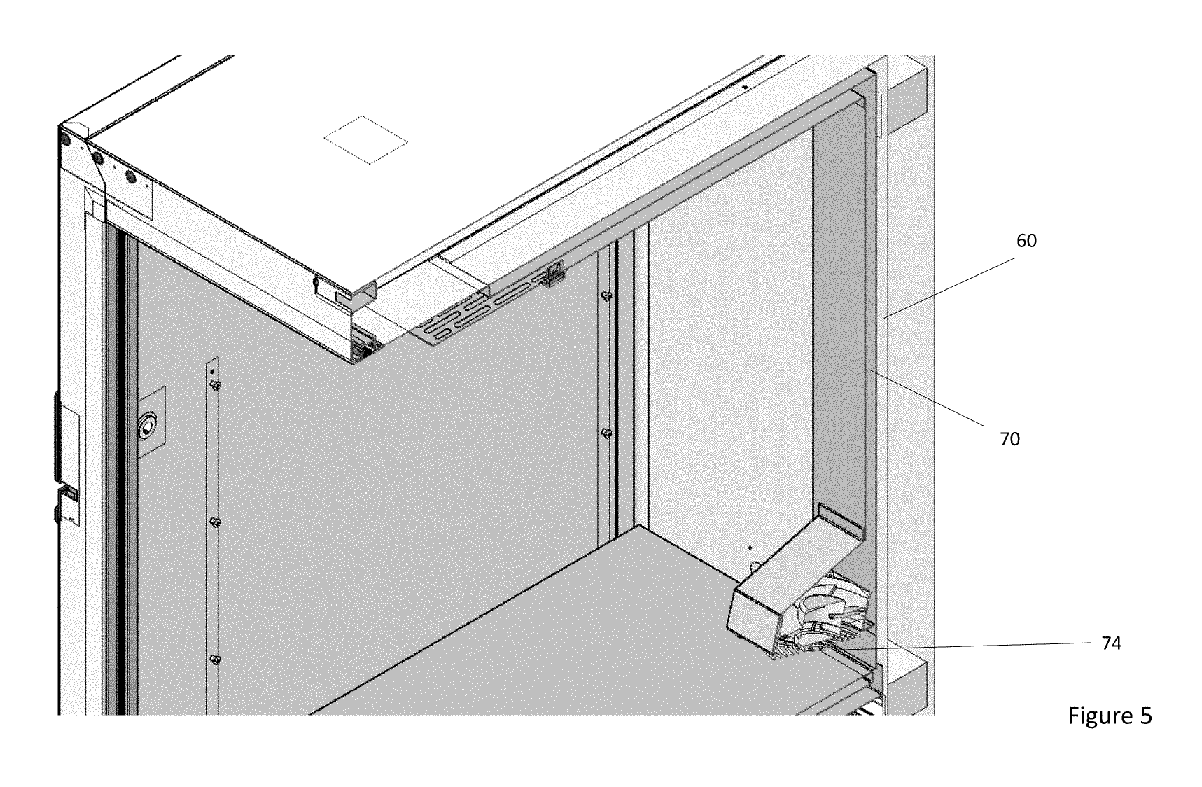

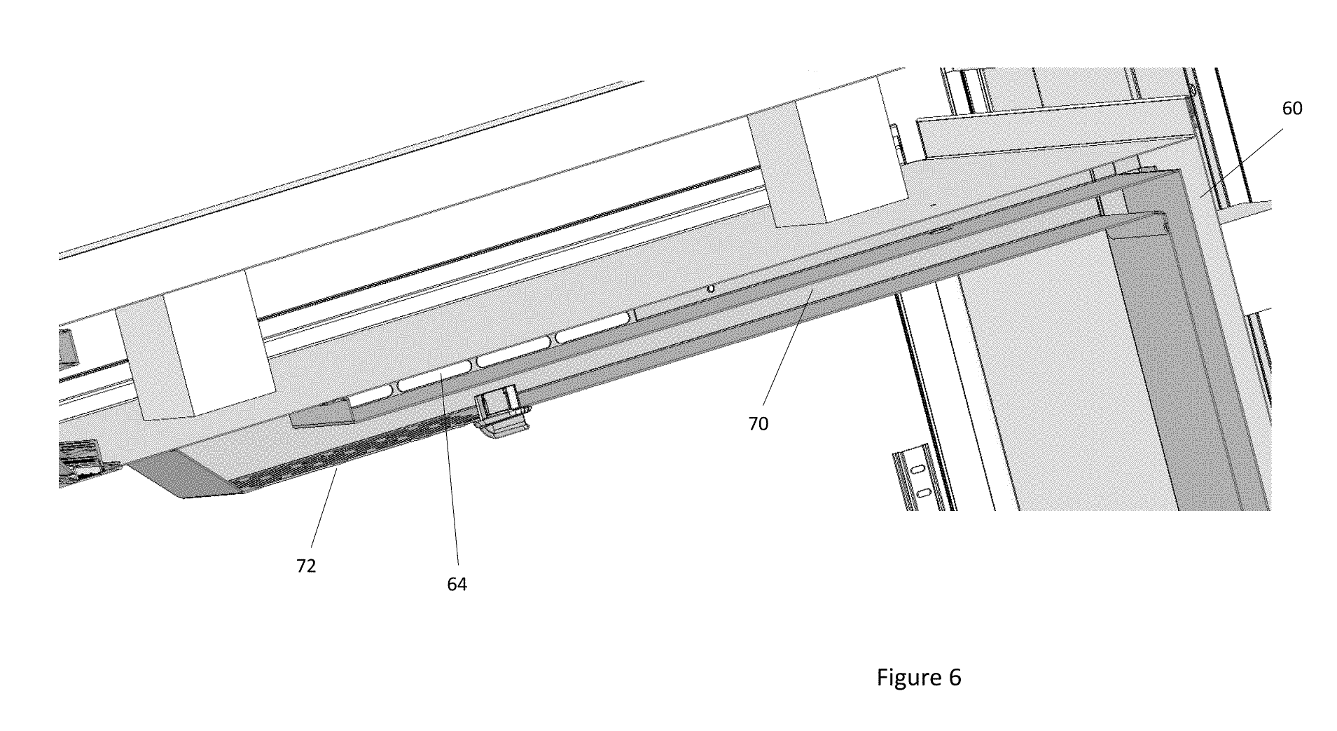

With reference to FIGS. 5 and 6 and according to one embodiment of the present invention, intake air from freezer compartment travels in the backwall portion of intake channel 60 while recirculating air from the refrigerator compartment travels in the backwall portion of recirculating channel 70 superposed onto intake channel 60. Each backwall portion of intake channel 60 and recirculating channel 70 are independent from one another without any fluid communication between each channel. Upon air reaching the top portion of the intake channel 60, the cold intake air will be discharged within the refrigerator compartment through the independent outlet ports 64. Upon air reaching the bottom portion of the recirculating channel 70, the recirculating air will be discharged within the refrigerator compartment through the outlet port 74. Outlet ports 64 are located on vertically oriented surfaces and the inlet ports 72 are located horizontally oriented surfaces.

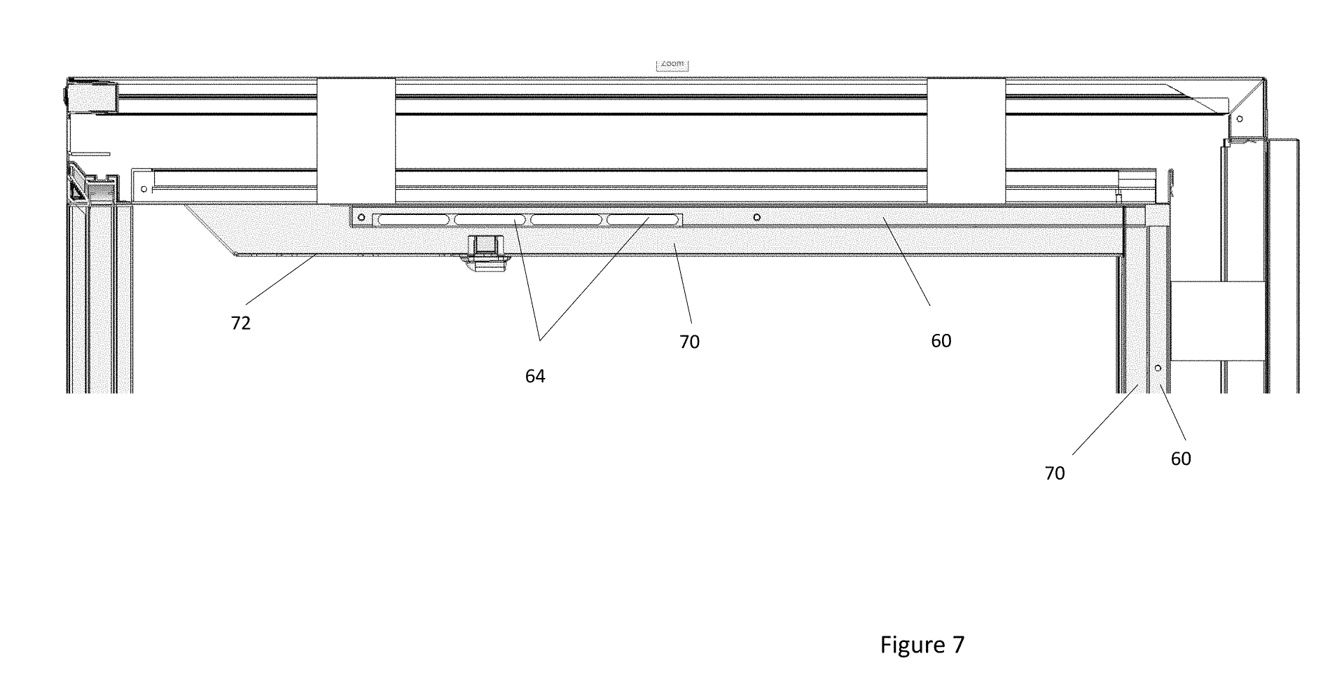

With reference to FIG. 7 and according to one embodiment of the present invention, outlet port 64 is shown being in a ninety (90) degree orientation relationship with inlet port 72 for recirculating channel 70. Such a relationship allows the mixing of cold air from the freezer compartment with air being recirculated in the refrigerator compartment.

The use of intake channel 60 in fluid communication with freezer compartment 30 allows cold air from the freezer compartment to be used for cooling the refrigerator compartment and removes the need for an independent refrigeration unit for the refrigerator compartment. The activation of the fans within the intake channel and recirculating channel is monitored by a control in the refrigerator freezer unit based on temperature measurements within the respective compartments. The controls used to regulate the temperature within each compartment are based on controls as would be known by a worker skilled in the relevant art.

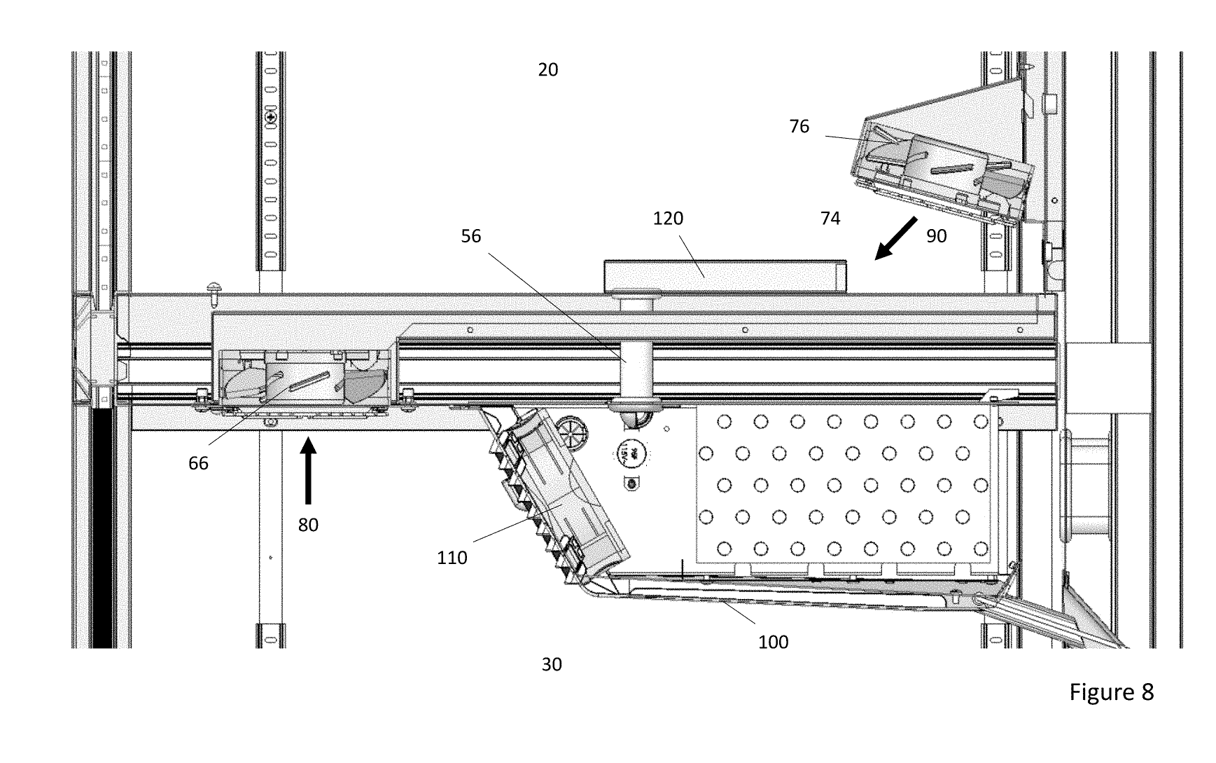

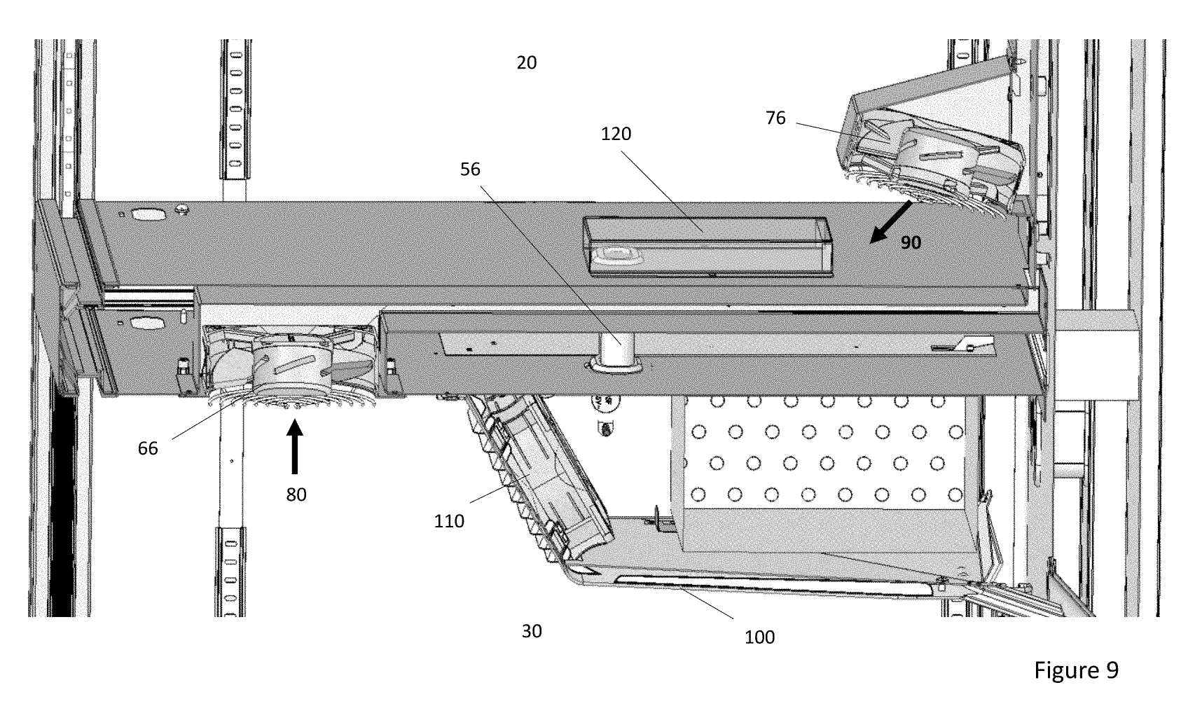

With specific reference to FIGS. 8 and 9 and according to another embodiment of the present invention, louvers 52 and 54 are not located as shown in FIG. 2c, FIG. 2d, and FIG. 3. In this alternate embodiment, a louver 56 is positioned in fluid communication with the refrigerator compartment 20 and the evaporator fan and coil housing 100. Air flow 80 within intake channel remains similar as previously described. Air flow 90 within recirculating channel also remains similar as previously described. Louvered opening 56 is positioned next to outlet port 74 of recirculating air flow 90 allowing air from the refrigerator compartment 20 to travel to the freezer compartment 30. An isolation channel 120 is positioned over louvered opening 56 in order to direct air flow 90 of recirculating channel within louvered opening 56. The isolation channel 120 has a single opening positioned at the channel side facing air flow 90 from exhaust port 74.

With further reference to FIGS. 8 and 9 and according to another embodiment of the present invention, the air balance within the refrigerator freezer unit with the presence of louver 56 will be maintained based on the pressure difference between the refrigerator and freezer compartments 20 and 30. The pressure is controlled through the operation of the evaporator fan 110, intake fan 66 and the recirculating fan 76. The operating state of these three fans determines air flow modes between the refrigerator compartment 20 and the freezer compartment 30. A first flow mode is created with the intake fan 66 and recirculating fan 76 being in an ON state, and the evaporator fan 110 being at either ON or OFF state. In this operating mode, the intake fan 66 will create a positive air pressure within the refrigerator compartment 20 which will force air into the freezer compartment 30 through louver 56 and subsequently through evaporator fan housing 100. In the second flow mode, the intake fan 66 is in an OFF state while the recirculating fan 76 and the evaporator fan 110 are in an ON state. In this second flow mode, a counter-pressure will be created at the isolation channel 120 to counteract the positive air pressure in evaporator fan housing 100. This counter-pressure prevents, or minimizes, the inflow of cold air from the evaporator fan housing 100 through louver 56 into the refrigerator compartment 20.

A worker skilled in the relevant art would be familiar with the use of a varying number of evaporator fans within the evaporator housing. The present description references only one evaporator fan which reference is only made for clarity and is not meant to be limiting. The present description references only one louver 56 which reference is only made for clarity and is not meant to be limiting.

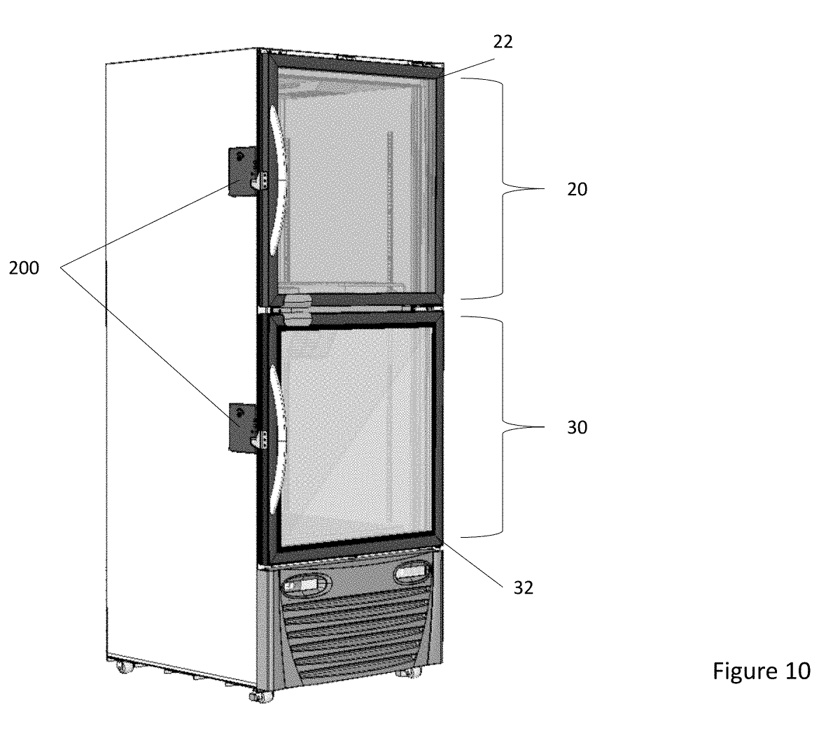

With reference to FIG. 10 a refrigerator freezer unit 10 is shown as described in previous Figures. The refrigerator freezer unit 10 has two safety locks 200 interconnected to the refrigerator and freezer compartments 20 and 30 respectively. Safety locks 200 allow locking of each compartment independently based on control signals sent from programmable refrigeration controllers positioned within the compressor compartment of the unit 10 which is typically within the base of 10 and is a known application to a skilled worker in the relevant art. The programmable controller monitors various parameters within the refrigerator and freezer compartments 20 and 30. From this monitoring and based on set operational parameters within the programmable refrigeration controller, the safety locks 200 can be activated to lock the doors 22 or 32 of each compartment 20 and/or 30. For example, if the programmable refrigeration controller detects a rise of temperature above an allowable maximum safe refrigeration level for a set time, then doors 22 and/or 32 can be locked out to prevent access to potentially unsafe items within compartments 20 and/or 30.

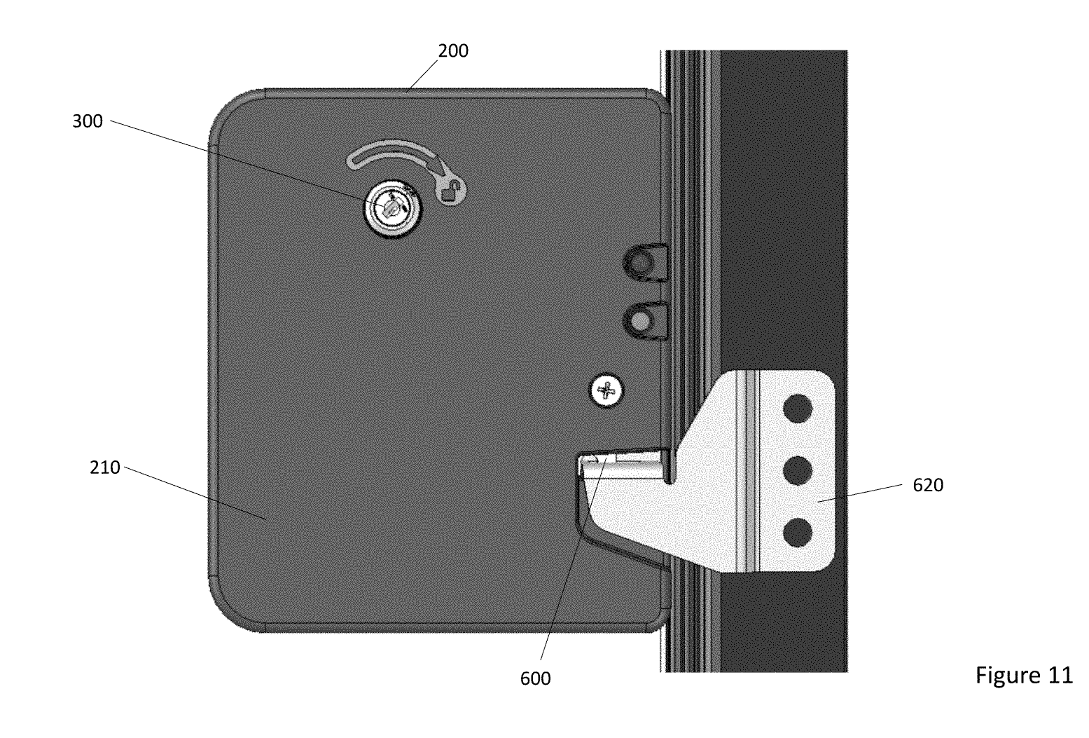

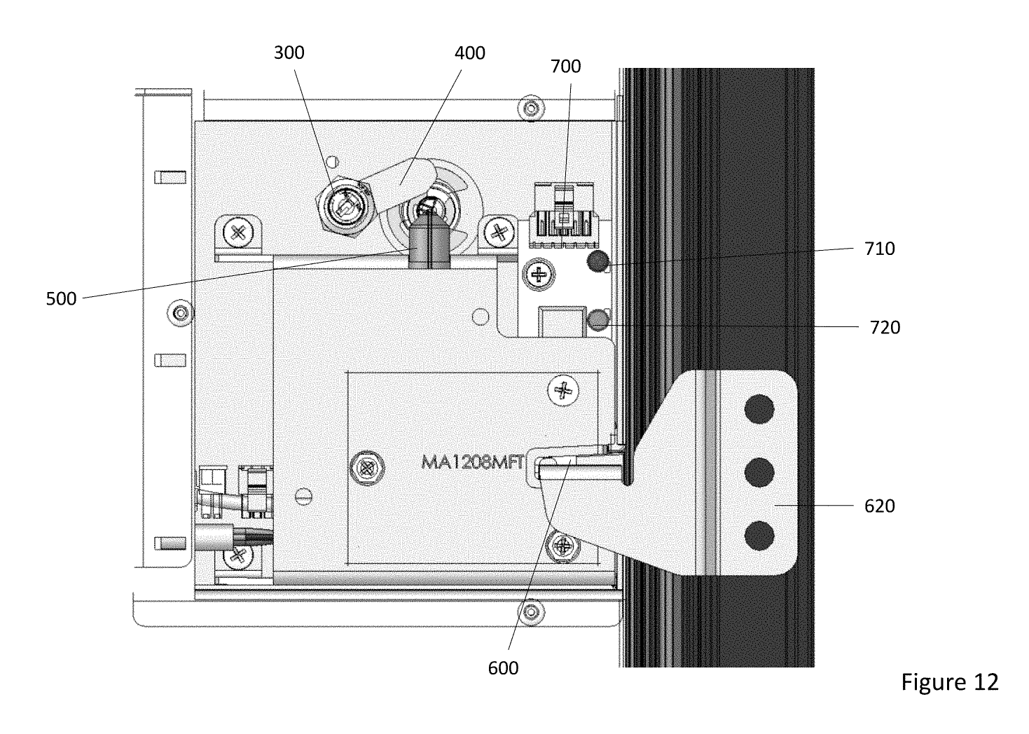

With reference to FIGS. 11 and 12 and according to one embodiment of safety locks 200, the safety lock 200 is housed within an outer shell 210 allowing isolation of all components of the safety lock while simultaneously maintaining the thermal barrier of the refrigerator freezer unit. Actuator 300 allows to manually unlock safety lock 200 by rotating the actuator 300 with a special purpose key. Actuator 300 is connected to a release cam 400. Release cam 400 is interconnected to a lock release pin 500 which is interconnected to mechanical lock 600 allowing to unlock the safety lock 200. A mechanical movement of Actuator 300 will move the release cam 400 which in turn will move release pin 500 and unlock mechanical lock 600. The controlled locking and unlocking of mechanical lock 600 is controlled by the programmable refrigeration controller and printed circuit board 700. The printed circuit board 700 has visual indicators 710 and 720 in order to indicate the locked or unlocked status of safety lock 200 and board power presence. The indication of the safety lock 200 being locked or unlocked is indicated through visual indicator 710 being an illuminated flashing red light for a lock status and no illumination for an unlocked status. Visual indicator 720 is a green light for indicating the presence of electrical power to safety lock 600. For thermal heat management, the control board 700 applies a varied voltage level to the solenoid of the safety lock 200. Upon receipt of a locking signal from the programmable controller, the circuit board 700 applies an initial 12 VDC for several seconds to the lock solenoid, and then drops the voltage to a holding 6 VDC continuous level. With further reference to FIGS. 11-12, mechanical lock 600 interconnects with a locking aperture 620 which is defined in this embodiment as a locking bracket which is positioned on doors placed onto a refrigerator or freezer compartment for example. A locking aperture under the present invention encompasses any type of application which can allow for a mechanical lock to be secured to it as would be known by a worker skilled in the relevant art.

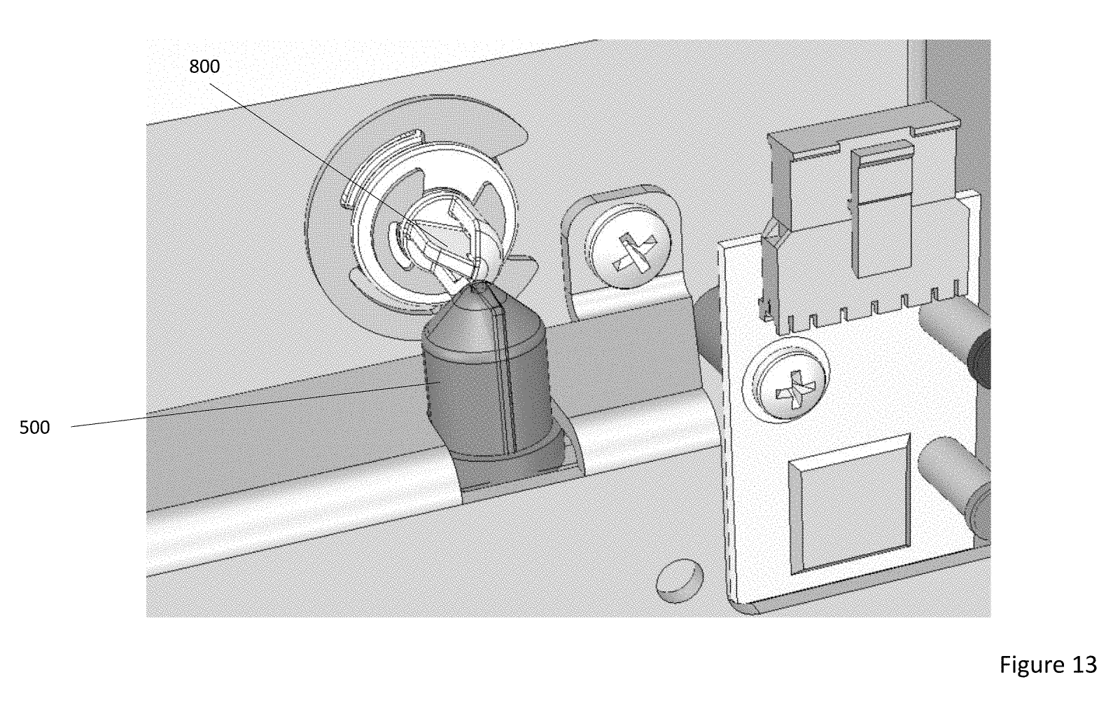

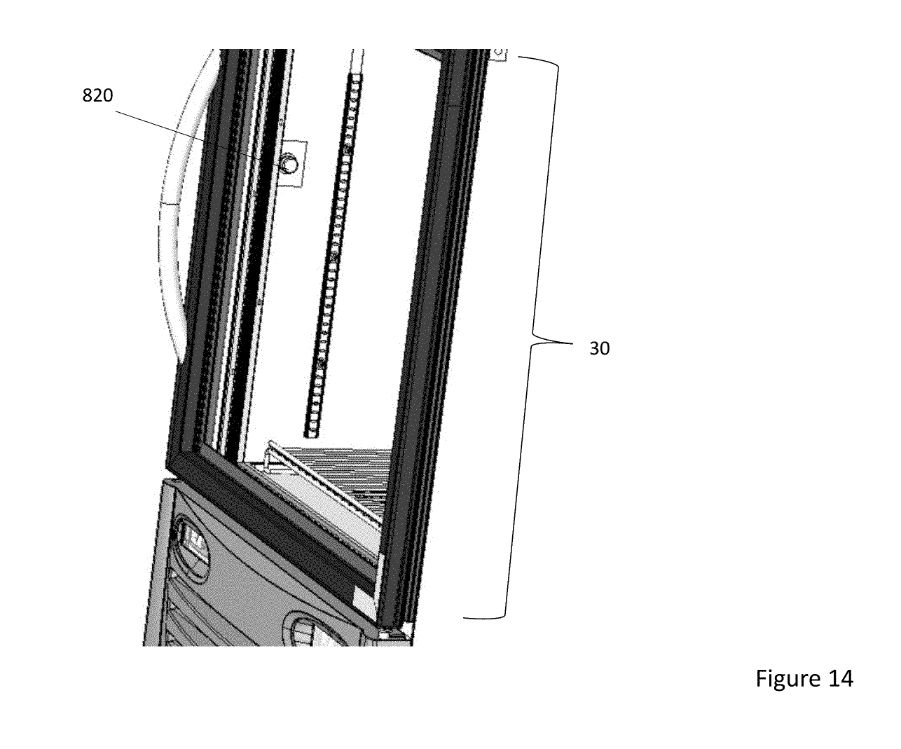

With reference to FIGS. 13-14 and according to one embodiment of the safety lock, an entrapment release 800 is interconnected to lock release pin 500. Entrapment release 800 allows to unlock the safety lock from within a refrigerated compartment for a safe escape in an event of human entrapment. Activation of the entrapment release 800 is through button 820 positioned within a refrigerator compartment 20 or freezer compartment 30. By pressing button 820, entrapment release 800 presses against release pin 500 which in turn releases the mechanical lock of the safety lock. The presence of the release cam and the entrapment release allows the safety lock to be unlocked through two independent releases.

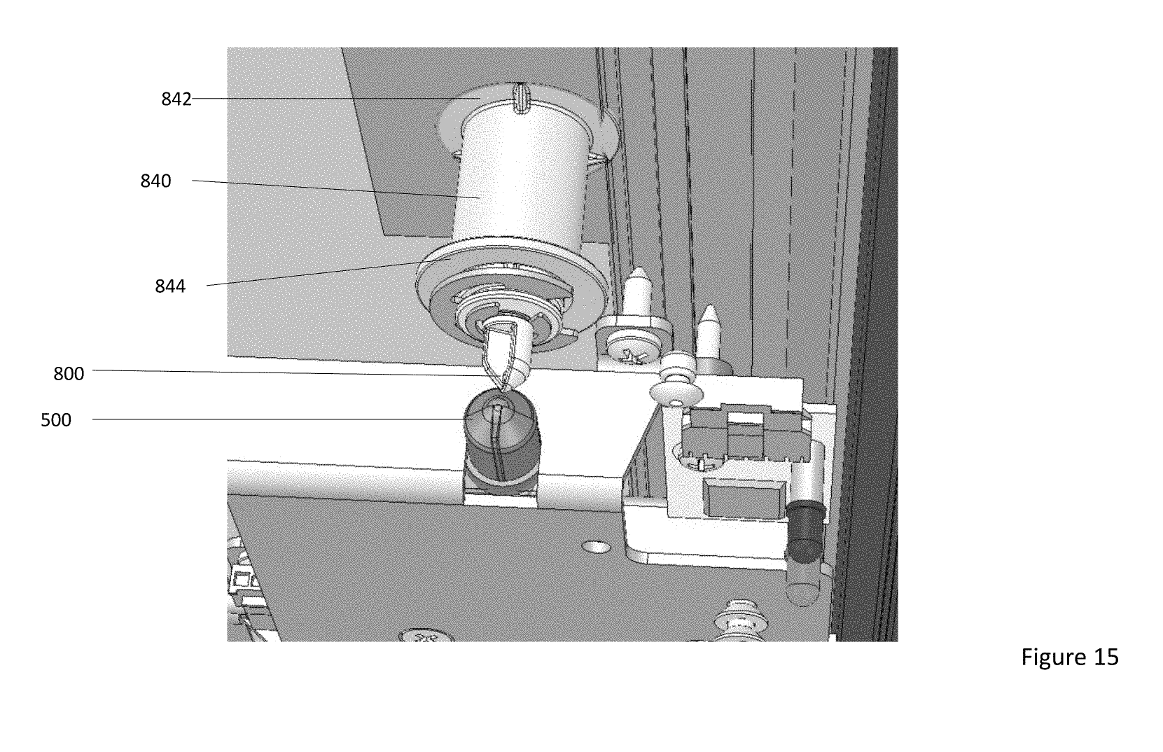

With reference to FIG. 15 and according to one embodiment of the safety lock, the entrapment release has a tubular body 840 allowing to thermally seal the inner and outer walls of the refrigerator freezer unit while providing a release button within a refrigerated compartment such as a refrigerator or freezer compartment. The tubular body 840 has one end 842 within a refrigerated compartment while its opposing end 844 is positioned within the safety lock. The outer wall of refrigerator freezer unit has been removed in FIG. 15 in order to show the tubular body 840 housing entrapment release 800.

The use of a lock release pin interconnected to both the release cam and entrapment release allows to unlock the safety lock from either the exterior or interior of the unit while maintaining the wall integrity of the unit.

The use of a single refrigeration unit for both the refrigerator and freezer compartment also requires less use of energy since there is only a single refrigeration unit and not two.

The placement of louvered openings within the floor of refrigerator compartment provides a balancing pressure in order to maintain a more consistent desired temperature within in each compartment and to allow the return of warm air from refrigerator compartment to freezer compartment.

The term fluid communication can also be interpreted as being interconnected with another element of the present invention.

A person understanding this invention may now conceive of alternative structures and embodiments or variations of the above all of which are intended to fall within the scope of the invention as defined in the claims that follow.

1. A refrigerator freezer unit comprising:
a) A single refrigeration unit connected to a freezer chamber for providing cold air to a freezer compartment;
b) An intake channel interconnected to the freezer chamber for providing cold air to a refrigerator compartment;
c) A recirculating channel allowing to recirculate air within the refrigerator compartment;
d) One or more intake fans positioned in the intake channel for displacing air in the intake channel; and
e) One or more recirculating fans positioned in the recirculating channel for displacing air in the recirculating channel
wherein the refrigerator and freezer compartments are cooled by the single refrigeration unit.

2. The refrigerator freezer unit according to claim 1 wherein the recirculating channel is superposed on the intake channel.

3. The refrigerator freezer unit according to claim 1 further comprising louvered openings allowing warm air to travel from refrigerator compartment to freezer compartment.

4. A safety lock for use with a refrigerator and/or freezer compartments comprising:
a) A mechanical lock for interconnection to a locking aperture;
b) A lock release pin interconnected to the mechanical lock allowing to unlock the mechanical lock with the locking aperture;
c) A release cam interconnected to the lock release pin allowing to unlock the mechanical lock by movement of the release cam;
d) An actuator interconnected to the release cam allowing to move the release cam into contact with the lock release pin;
e) An entrapment release interconnected to the lock release pin allowing to activate the lock release pin from within the refrigerated compartment; and
f) A circuit board allowing to provide varied power levels to the mechanical lock and to lock and unlock the mechanical lock based on measured parameters within the refrigerated compartment by a refrigeration controller.
